(19) United States
(12) Patent Application Publication
(10) Pub. No.: US 2004/0232599 A1
(43) Pub. Date: Nov. 25, 2004

(54) Mold for tires

(75) Inventor: Alain Soulalioux, Saint-Beauzire (FR)

Correspondence Address: FITZPATRICK CELLA HARPER & SCINTO, 30 ROCKEFELLER PLAZA, NEW YORK, NY, 10112, US

(73) Assignee: MICHELIN RECHERCHE ET TECHNIQUE S.A.

(21) Appl. No.: 10/833,253

(22) Filed: Apr. 27, 2004

Related U.S. Application Data
(63) Continuation of application No. PCT/EP02/12685, filed on Nov. 13, 2002.

(30) Foreign Application Priority Data
Nov. 13, 2001 (FR) 01/14679

(51) Int. Cl. B29C 35/00

(52) U.S. Cl. 264/326; 425/47; 425/812

(57) ABSTRACT

The mold for a tire has a laminated peripheral crown. It is formed by a stack in the circumferential direction of a plurality of thin metal sheets 1 adjacent to one another. The said metal sheets are grouped into sectors 11 thus forming monobloc subassemblies.

### CROSS REFERENCE TO RELATED APPLICATIONS

This application is a continuation of international application PCT/EP 02/12685 filed Nov. 13, 2002, which was published in French as international publication WO 03/041932 A1 on May 22, 2003 and which claims priority to French application 01/14679 filed Nov. 1,3 2001.

### BACKGROUND OF THE INVENTION

1. TECHNICAL FIELD OF THE INVENTION

The present invention relates to the manufacture of tires. More particularly, it relates to the molding of the tread thereof.

2. The Related Art

The patent application EP 0 569 909 describes a type of mold in which a very large number of transversely disposed metal sheets provide for molding of the tread. The molding surface is formed by the set of the cut edges of each metal sheet. The metal sheets, being oriented transversely, extend from one shoulder of the tire to the other. The patent application EP 0 860 260 proposes keeping the orientation of the metal sheets as perfectly radial as possible as a result of intermediate metal sheets which themselves engage in slots made in a support ring and are hence guided strictly.

In all the cases envisaged, opening and closing this type of mold necessitates the provision of a coordinated displacement in a radial direction of all the metal sheets which overall form a laminated peripheral crown. It may be that parasitic friction occurs, impeding the movements of opening and closing the mold. Furthermore, it may prove difficult to keep the distribution of the amounts of play between metal sheets as regular as is desired. Consequently, mold flash may appear where the play between metal sheets has become larger than the nominal play. The aim striven for here is to select the nominal play, as explained in the patent EP 0 569 909, specifically such that the rubber is prevented from being able to flow between the metal sheets during the entire course of closing the mold.

### SUMMARY OF THE INVENTION

The object of the invention is to obviate this disadvantage in order to improve the suitability of a mold of this type for molding tires with a high quality of appearance, in particular with a quality of appearance which remains constant after numerous molding cycles.

Another object of the invention is to facilitate the mounting of a mold of this type, whereof the very design necessitates a very large number of metal sheets to be manipulated, with the concomitant risk of mounting errors.

The invention proposes a mold for a tire tread, having a laminated peripheral crown for molding the outside of the tread, the said laminated peripheral crown comprising a stack in the circumferential direction of a plurality of thin molding elements adjacent to one another, the said elements being oriented substantially radially, molding of the said tread being effected by the radially inner cut edge of the said elements, the radially inner cut edge having the desired profile for molding a pattern on the tread, characterized in that the crown is divided into sectors and in that for each sector the elements belonging to one sector are integrally joined to form a unitary block, each sector being capable of displacement during the movements of opening and closing the mold.

In the present specification, when a part or surface is described as inner, this means that it is located towards the center of the mold, that is to say on the side of the inside molding cavity. When the description outer is used, this means that the surface or part is located further away from the said molding cavity. For example where the metal sheets molding the tread are concerned, the inner cut edge is the molding surface, in contact with the rubber during molding, while the outer cut edge or side is the surface in contact with a support of the metal sheets.

The invention also extends to a method of manufacturing a tire using a mold such as has just been described. In this case, an advantage of using this mold resides in the fact that it contributes to excellent venting during molding, through gaps between metal sheets.

For a general description of the functioning of a mold of this kind, the reader is referred to the patent EP 0 569 909 mentioned above, and in particular the part of that patent relating to FIG. 5.

### BRIEF DESCRIPTION OF THE DRAWINGS

The figures below illustrate the invention and enable all the advantages thereof to be appreciated.

FIG. 1 is a perspective view showing two sectors spaced from one another, as they might be when the mold is opened, in accordance with the invention in its application to a first type of mold, showing a first variant embodiment of the invention.

FIG. 2 is a section through a center plane of the mold of the invention in its application to a first type of mold, in the molding position, that is to say with the mold closed.

FIG. 3 is a section through a plane perpendicular to the axis, with the mold closed, showing the first variant of the invention.

FIG. 4 is a section through a plane perpendicular to the axis, with the mold open, showing the first variant of the invention.

FIG. 5 is a section through a center plane of the mold of the invention in its application to a second type of mold, in the molding position, that is to say with the mold closed.

FIG. 6 shows a second variant embodiment of the invention.

FIG. 7 shows a third variant embodiment of the invention.

FIG. 8 shows a fourth variant embodiment of the invention.

FIG. 9 is a view along F in FIG. 8.

FIG. 10 shows a fifth variant embodiment of the invention.

### DETAILED DESCRIPTION OF THE INVENTION

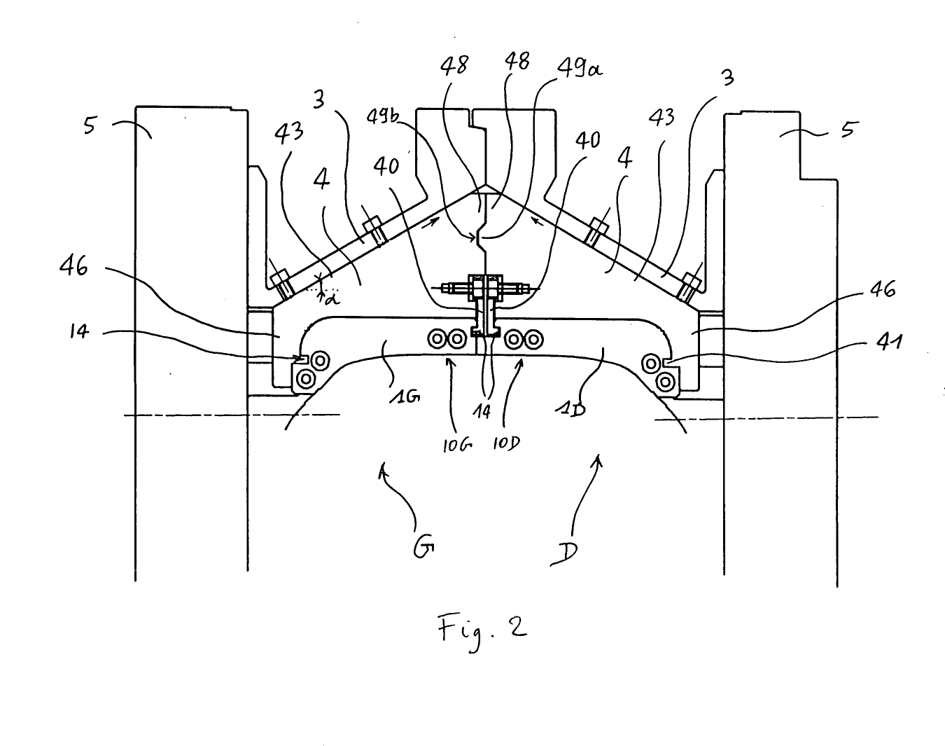

In this embodiment of the mold, the molding elements of the laminated peripheral crown serving to mold the tread are metal sheets 1 adjacent to one another, whereof the thickness is between 0.1 mm (preferably 0.5 mm) and 5 mm (see FIG. 2). A laminated crown comprises several thousand adjacent metal sheets. This is a very advantageous method of making the thin elements characteristic of this type of mold. The thickness of the metal sheets corresponds to the resolution of the mold to define the pattern. Sheets of steel are for example used; these are advantageously all cut out perpendicular to their plane in a profile dictated by the tread patterns to be made. By always cutting out the sheets perpendicularly, some surfaces of the tread pattern will look like the steps of a staircase, which gives an appearance characteristic of this technology. Preferably, the side faces of the metal sheets are not parallel so as to place them naturally in a fan shape when they are put together, and to have a substantially constant amount of play between them. On this subject, the reader is referred to the patent applications EP 0 916 419 and EP 0 916 421.

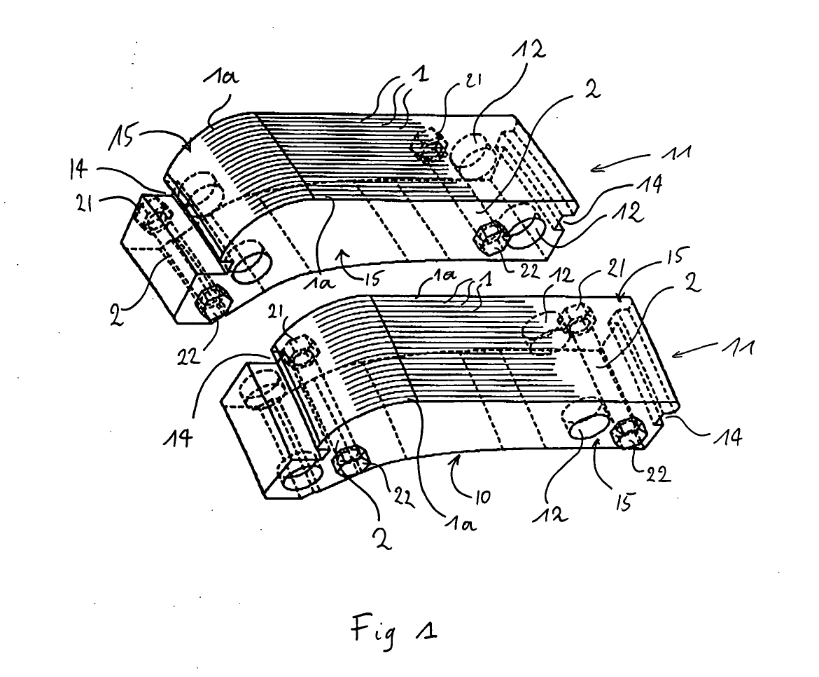

FIG. 1 shows that the crown is divided into two parts (G and D) and that the crown has, transversely, two distinct metal sheets (1G and 1D) adjacent to one another and each belonging to one of the parts. The metal sheets or molding elements are designated in general by the reference numeral 1. If the intention is more specifically to design an element or a part element belonging to part G, the reference numeral 1G is used. If the intention is more specifically to design an element or a part element belonging to part D, the reference numeral 1D is used.

Preferably, at least the end on the molding part side, that is the side with the cut edge 10 of the metal sheets 1, has a progressively decreasing thickness in the direction radially towards the axis of the mold. Each of the metal sheets thus forms a slight wedge whereof the angle corresponds substantially to the value obtained by dividing 360° by the number of metal sheets on a circle of the peripheral molding crown.

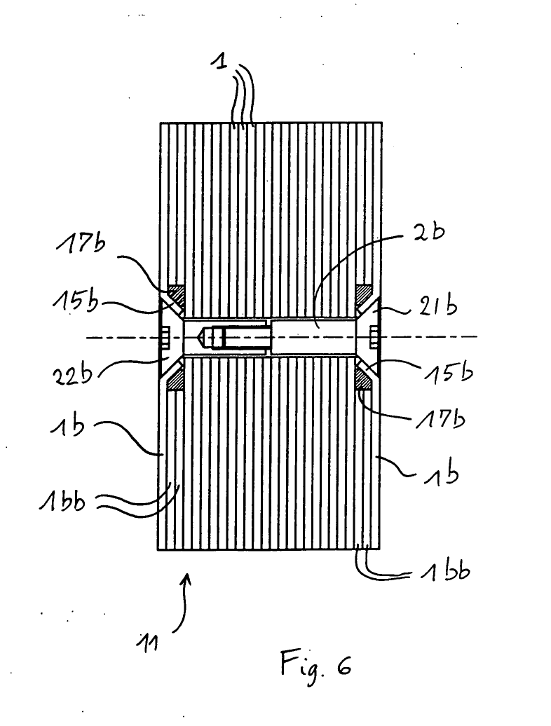

To form the laminated peripheral crown, the metal sheets 1 are grouped by sectors 11, as is very clear in particular from FIGS. 1, 3 and 4. To this end, the metal sheets 1 of a sector 11 are grasped by a fixing device having two protruding heads, such as a bolt 2 (whereof the head forms a first head 21) and a nut 22 (forming the second head). The head 21 of each bolt 2 and the nut 22 bear against the free side 15 of each of the metal sheets 1a at the edge of each sector 11. The fixing devices (units comprising bolt 2 and nut 22 together) are disposed alternately from one sector to the next (see FIGS. 1 to 4), each sector having recesses 12 allowing the head of the fixing devices of adjacent sectors to be housed. The recesses 12 are obtained by making holes in a sufficient number of metal sheets when the said sheets are cut out. This allows the sectors to be brought into contact (see FIG. 3) to form the continuous crown ensuring molding of the tread. In passing, it should be pointed out that the consequence of this type of holding means is that there is necessarily an even number of sectors for molding the entire tread, whether there are two axial parts G and D or not, but this is not necessarily the case for all types of holding means (see for example FIGS. 6, 7 and 8).

The number of elements per sector is typically between 10 and 1,000. The number of elements is identical for all sectors, or different from one sector to another.

Different means may be used to manipulate the groups of metal sheets that are assembled and held in sectors. This is to organize the sector movements required to open and close the mold. For example, the metal sheets belonging to one sector may be fixed to a casing, each casing being capable of displacement during the movements of opening and closing the mold.

FIG. 2 shows that each sector 11 is mounted on a casing 4 forming a monobloc support, which may be a standard part common to a large number of different tread patterns. Even if a casing 4 is, of course, adapted to the dimension of a tire since it is not in itself molding, it may be used for a plurality of different patterns and is not therefore specific to a single tire. To bring about this fixing, the metal sheets are cut out so as to obtain grooves 14 engaging with a protuberance 41 made on one side of the casing 4, the sector being held immobile by a collar 40, also gripped in another groove 14 on this metal sheet and screwed to the casing 4. Thus, the metal sheets 1 belonging to a sector 11 are fixed to a casing 4, each casing 4 then being capable of displacement during the movements of opening and closing the mold. The number of metal sheets may be identical for all sectors, or the sectors may bring together a different number of metal sheets.

Each of the casings has, besides the protuberance 41, a side edge 46, a back 43, and a central edge 48 intended to come into contact with the corresponding central edge 48 on the adjacent casing of the other part. Note also the presence of a lug 49a on each of the casings 4 of part D, engaging in a cutout 49b made in each of the casings 4 of part G, in order to position the casings 4 and hence the metal sheets 1 very precisely at the same radial height during the entire phase of closing the mold, in particular during the final phase of closing.

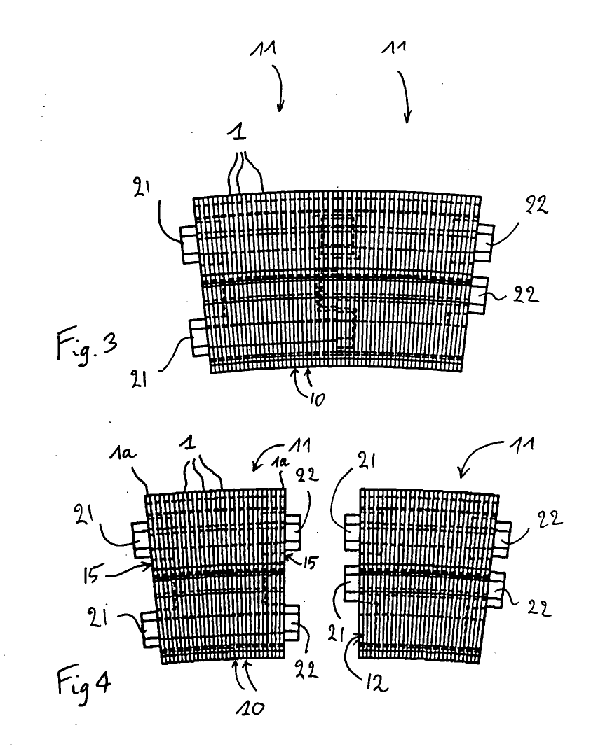

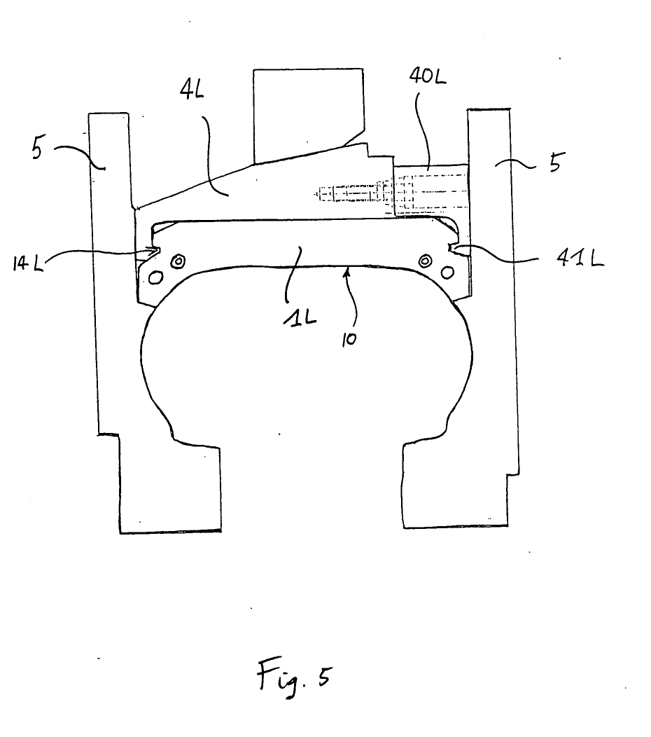

Each of the casings 4 is mounted on a ramp 3 by means of a slideway (not illustrated) in order to allow a relative movement symbolized by an arrow drawn on the back of the casing. In this example, each of the parts G and D of the mold has a plate 5 on which there is mounted a ramp 3. The ramp 3 has a radially inner frustoconical bearing surface 30 at an angle a in contact with the said casings 4. This ramp allows the movement of the casings 4 to be controlled to bring them into their closed position, as illustrated in FIG. 2, or to bring them into their open position (not illustrated in FIG. 2, but corresponding to the groups of metal sheets in FIG. 4), as known per se for molds in sectors with two axial parts.

In each sector, the metal sheets 1 are mounted on the casing and all disposed at the same angle with respect to the radial direction. In this example, the metal sheets are disposed centrally. In other words, when the laminated peripheral crown is seen in section along a plane perpendicular to the geometric axis of the mold (see FIG. 3), the metal sheets are disposed so as to have a radius, and their virtual extension is the geometric axis of the mold. This is in no way restrictive, and it is possible for the metal sheets to be slightly inclined.

In FIG. 5, it is shown that the invention is not limited to the type of mold having two axial parts (G and D), but may equally well be applied advantageously to another type of mold, in one axial piece. In this case, the elements used are metal sheets 1L whereof the width corresponds substantially to the width of the tread. Each sector is mounted on a casing 4L also forming a monobloc support, and may also be a standard part of adapted width, common to a large number of different tread patterns. The metal sheets 1L are fixed thanks to grooves 14L engaging with protuberances 41L made on one side on the casing 4L and on the other on a collar 40L which is screwed to the casing 4L.

Numerous variant embodiments may be envisaged to keep the metal sheets 1 together by sector 11. Thus, in the bolts 2 shown in FIGS. 1 to 4, where the heads 21 and the nuts 20 are seen to protrude, it is possible to replace them (see FIG. 6) with screws 2b whereof the corresponding heads 21b and nuts 20b are frustoconical in shape and are embedded within the thickness of each sector, the headings 21b and nuts 20b cooperating with a frustoconical bearing surface 15b made on the metal sheets 1b installed at the edges of each sector. It should be noted that in the embodiment illustrating this specification two metal sheets 1bb immediately adjacent to the metal sheets 1b at the sector edge have a larger hole, allowing a washer 17b to be housed when the mold is mounted, the washer 17b enabling the clamping forces to be taken up and the alignment of the metal sheets in the sector to be ensured.

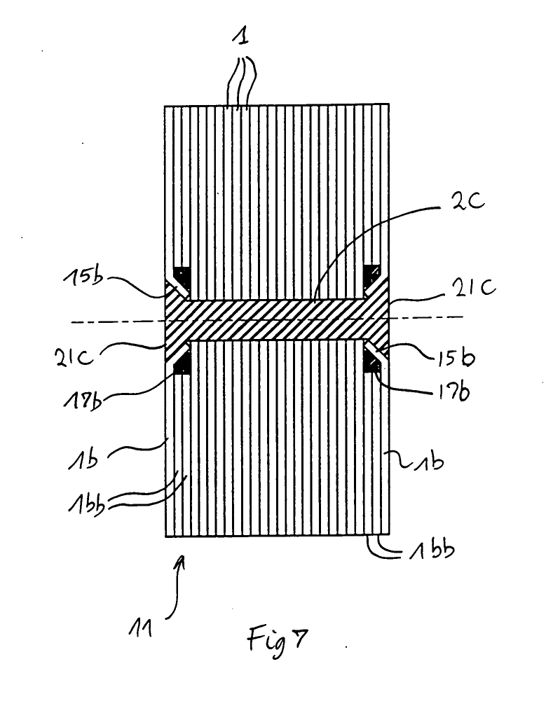

In FIG. 7, it is seen that the metal sheets 1 are kept pressed to one another by a fixing insert 2c obtained by injecting plastics or any other convenient material, the metal sheets being pre-assembled and held temporarily while the insert 2c is made. This insert 2c has heads 21c which are frustoconical in shape. Once the insert 2c has been fully made, the heads 21c cooperate with a frustoconical bearing surface 15b made on the metal sheets 1b installed at the edges of each sector, exactly as in the variant above.

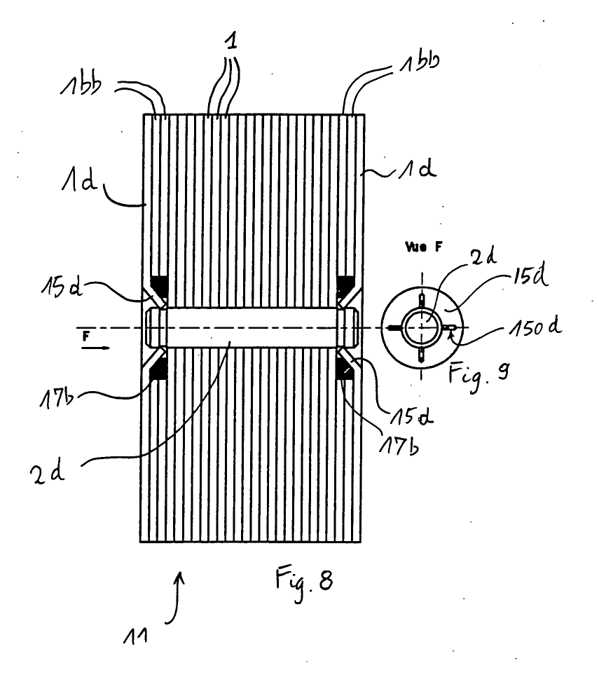

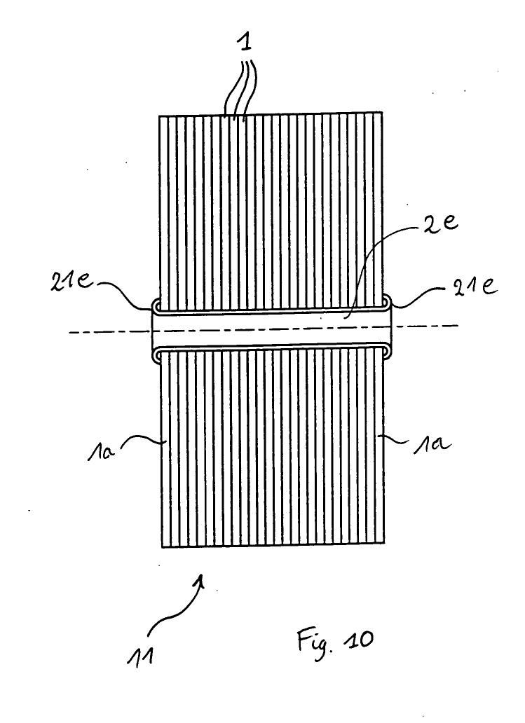

In FIGS. 8 and 9, it is seen that the metal sheets 1 are held pressed to one another by a fixing pin 2d having two grooves 21d. The metal sheets 1d installed at the edges of each sector have one or more frustoconical bearing surfaces 15d having slots 150d giving them a certain elasticity. When the insert 2d is mounted, the edge of the frustoconical bearing surfaces 15d is inserted in the grooves 21d, to ensure the clamping forces are taken up.

In FIG. 10, it is seen that the metal sheets 1 are kept pressed to one another by a rivet 2e. The insert 2e has ends 21e bearing against the side face of each metal sheet 1a provided at the edges of a sector. Of course, those skilled in the art will have understood that numerous other variant embodiments of the function of keeping the metal sheets of a sector together may be envisaged without departing from the scope of the present invention.

The invention enables molds to be made in a way that is well suited to the techniques of computer aided design and manufacture, with a very short time to implementation. The molds made in this way are very robust; they accommodate themselves very well to a large number of opening and closing cycles.

What is claimed is:

1. A mold for a tire tread, having a laminated peripheral crown for molding the outside of the tread, the said laminated peripheral crown comprising a stack in the circumferential direction of a plurality of thin molding elements adjacent to one another, the said elements being oriented substantially radially, molding of the said tread being effected by the radially inner cut edge of the said elements, the said radially inner cut edge having the desired profile for molding a pattern on the tread, characterized in that the crown is divided into sectors and wherein for each sector the elements belonging to one sector are integrally joined to form a unitary block, each sector being capable of displacement during the movements of opening and closing the mold.

2. The mold according to claim 1, wherein the elements belonging to one sector may be fixed to a casing, each casing being capable of displacement during the movements of opening and closing the mold.

3. The mold according to claim 1, wherein the crown is divided into two parts (G and D) and wherein the crown has, transversely, two distinct elements adjacent to one another and each belonging to one of the parts.

4. The mold according to claim 1, wherein each element has a thickness between 0.1 mm and 5 mm, and wherein the end on the molding cut edge side of the said elements has a progressively decreasing thickness in the direction radially towards the axis of the mold.

5. The mold according to claim 1, wherein the number of elements per sector is between 10 and 1,000.

6. The mold according to claim 1, wherein the number of elements is identical for all sectors.

7. The mold according to claim 1, wherein the sectors bring together a different number of elements.

8. The mold according to claim 1, wherein the elements of a sector are grasped by a fixing device having two protruding heads, each bearing against the free side of each of the elements at the edge of the sector, the fixing devices being disposed alternately from one sector to the next, each sector having recesses allowing the head of the fixing devices of adjacent sectors to be housed when the sectors are in contact to form the said crown for molding the tread.

9. The mold according to claim 1, having an even number of sectors.

10. A method of manufacturing a tire comprising molding the tire with a mold having a laminated peripheral crown for molding the outside of the tread, the said laminated peripheral crown comprising a stack in the circumferential direction of a plurality of thin molding elements adjacent to one another, the said elements being oriented substantially radially, wherein the molding of the said tread is effected by the radially inner cut edge of the said elements, the said radially inner cut edge having the desired profile for molding a pattern on the tread, wherein the crown is divided into sectors, wherein for each sector the elements belonging to one sector are integrally joined to form a unitary block, each sector being capable of displacement during the movements of opening and closing the mold, and wherein venting of the mold is effected by spaces between the elements.

11. The method of claim 10 wherein the elements belonging to one sector may be fixed to a casing, each casing being capable of displacement during the movements of opening and closing the mold.

12. The method of claim 10, wherein the crown is divided into two parts (G and D) and wherein the crown has, transversely, two distinct elements adjacent to one another and each belonging to one of the parts.

13. The method of claim 10, wherein each element has a thickness between 0.1 mm and 5 mm, and wherein the end on the molding cut edge side of the said elements has a progressively decreasing thickness in the direction radially towards the axis of the mold.
